(19) United States
(12) Patent Application Publication
(10) Pub. No.: US 2008/0143062 A1
(43) Pub. Date: Jun. 19, 2008

(54) Drill chuck

(75) Inventor: Hans-Dieter Mack, Sontheim (DE)

Correspondence Address: K.F. ROSS P.C., 5683 RIVERDALE AVENUE, SUITE 203 BOX 900, BRONX, NY, 10471-0900, US

(73) Assignee: ROHM GmbH

(21) Appl. No.: 11/999,674

(22) Filed: Dec. 6, 2007

(30) Foreign Application Priority Data
Dec. 11, 2006 (DE) 102006058199.7

(51) Int. Cl. B23B 31/12

(52) U.S. Cl. 279/62

(57) ABSTRACT

A drill chuck has a chuck body centered on and rotatable about an axis and a plurality of jaws spaced angularly about the axis, radially shiftable on the body between inner and outer positions, and each having a grip edge extending along a line substantially parallel to the axis and a pair of flanks meeting at the grip edge and extending generally radially outward therefrom. The flanks of each jaw diverge radially inward from the flanks of adjacent jaws so that a tool shank engaged between the flanks of two adjacent jaws will be pushed radially toward the axis on movement of the jaws inward from the outer positions.

### FIELD OF THE INVENTION

The present invention relates to a drill chuck.

### BACKGROUND OF THE INVENTION

A standard drill chuck has a chuck body centered on and rotatable about an axis, normally by a power-drill spindle. A plurality of jaws radially spaced about the axis are movable radially and also normally axially between outer and inner positions under the control of a mechanism normally having a screwthread connection that effects the displacement. Each jaw in turn typically has a grip edge that extends along a line that is parallel to the axis regardless of the position of the jaw and that engages the tool in line contact when the chuck is closed on the tool, typically a cylindrical shank of a drill bit. To each side of the grip edge, each jaw normally has a pair of planar flanks that slope identically away.

The apex angle of the flanks of each jaw are normally such that, when there is nothing between the jaws, they can be brought together to a position with the grip edges all touching and the flanks flatly engaging each other and extending radially of the chuck axis. Thus in a typical three-jaw chuck, the flanks extend at 120° to each other.

Whether the chuck is used for milling, drilling, or another machining process it is critical that the bit be held perfectly on center. Even the slightest off-center positioning can result in destruction of the bit and workpiece, and even create a dangerous condition for the user of the tool, especially at high rotation speeds.

A disadvantage of conventional hand-operated and also machine-operated chucks, in particular when working with bits of small diameter, is that they must be precisely precentered before clamping by the jaws. Otherwise they may be clamped off-center between the flanks of two adjacent jaws. This precise precentering is difficult to do in the field, resulting in broken bits and damaged workpieces.

### OBJECTS OF THE INVENTION

It is therefore an object of the present invention to provide an improved drill chuck.

Another object is the provision of such an improved drill chuck that overcomes the above-given disadvantages, in particular that allows even a bit or tool with a small-diameter shank to be chuck without any possibility of it being chucked off-center.

### SUMMARY OF THE INVENTION

A drill chuck has according to the invention a chuck body centered on and rotatable about an axis and a plurality of jaws spaced angularly about the axis, radially shiftable on the body between inner and outer positions, and each having a grip edge extending along a line substantially parallel to the axis and a pair of flanks meeting at the grip edge and extending generally radially outward therefrom. The flanks of each jaw diverging radially inward from the flanks of adjacent jaws so that a tool shank engaged between the flanks of two adjacent jaws will be pushed radially toward the axis on movement of the jaws inward from the outer positions.

Essentially, the advantage provided by the invention is that the chuck centers the tool or workpiece in a simple and economical manner solely by modification of components that are already present. For problem-free precentering of the tool shaft or the workpiece, the chuck may be opened until the distance between flanks of the jaws is less than or equal to the diameter of the workpiece or tool shaft to be clamped, or in the case of flat tool shafts, corresponds to the associated jaw span. After the tool or workpiece is introduced, the jaws may then be moved into the clamped position, thereby automatically and easily centering the tool shaft or workpiece to be clamped. In addition, it is generally possible for existing chucks to be easily and economically retrofitted with correspondingly designed jaws. Furthermore, the risk of injury to the user or nearby persons, in particular during loosening of the clamped tool or workpiece, is greatly reduced for chucks that are still rotating, since even for partially opened jaws the tool or workpiece remains clamped for a longer time between the flanks of the two jaws, and thus remains de facto for a longer time in the chuck.

Within the scope of the invention it is very particularly preferred for the chuck to have three jaws. This design has the advantage that tools or also workpieces may be centered in a very satisfactory manner, and the design of the chuck may be kept simple.

It is further particularly preferred for each of the flanks to have a concave design. This has the advantage that the grip edges define a smaller acute angle, thereby facilitating penetration of the grip edge into the tool shaft or workpiece, and allowing a greatly enhanced rotational connection between the jaw and the tool shaft or workpiece.

For further enhancing torque transmission between the jaws and the clamped tool shaft or workpiece, it is very particularly preferred for each jaw to have two grip edges that are parallel to one another and to the chuck axis. This provides the additional advantage that the maximum service life of the jaw may be further increased. According to one particularly preferred embodiment, the two grip edges of each jaw may be mirror-symmetric with respect to the center jaw plane passing through the chuck axis.

For simplified positioning of the tool or workpiece in the tool or workpiece receptacle defined by the jaws, the invention further provides that in the direction of introduction of the tool or workpiece the end faces of the jaws have a plane extending from the base of the jaws at an angle with respect to the chuck axis, or a concave surface.

### BRIEF DESCRIPTION OF THE DRAWING

The above and other objects, features, and advantages will become more readily apparent from the following description, reference being made to the accompanying drawing in which:

FIG. 1 is a partly sectional side view of how a three-jaw chuck together with a clamped tool;

FIG. 2 is a cross section through the jaws of a prior-art three-jaw chuck in the open position;

FIG. 3 is a view like FIG. 2 but in the fully closed position;

FIG. 4 is another view like FIG. 2 but with a properly clamped and centered tool;

FIG. 5 is yet another view like FIG. 2 but with the tool clamped off-center;

FIGS. 6 and 7 are views like FIG. 2 of jaws according to the invention in the open and fully closed positions, respectively;

FIGS. 8 and 9 are views showing how the jaws of FIGS. 6 and 7 act on an eccentrically positioned bit or tool when the chuck is tightened;

FIGS. 10, 11, 12, and 13 are views like FIG. 7 of a second, third, fourth, and fifth sets et of jaws according to the invention; and

FIGS. 14 and 15 are perspective views of jaws with planar and dished end faces.

### SPECIFIC DESCRIPTION

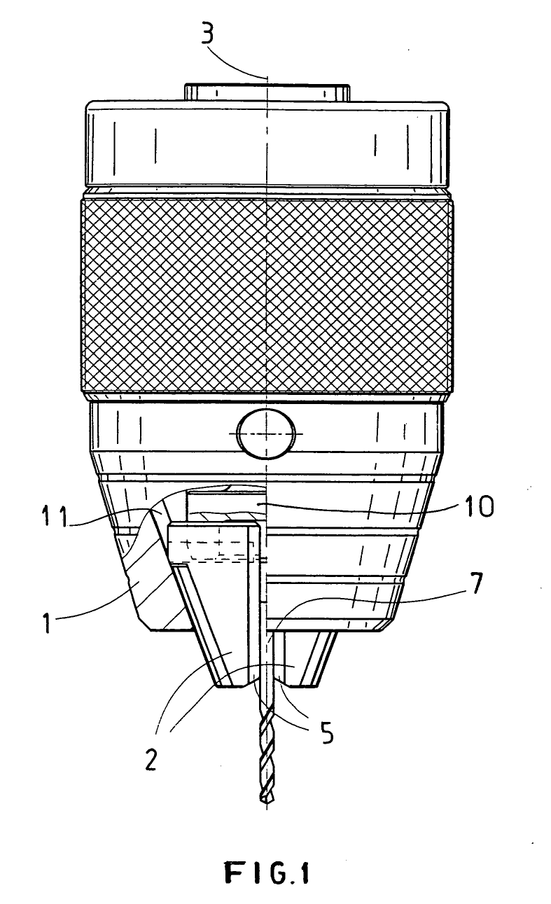

As seen in FIG. 1 a standard drill chuck has a body 1 centered on an axis 3 and provided with three identical steel jaws 2. Mechanism inside the body 1 including a pusher 10 and angled guides 11 can shift the jaws 2 together axially and radially to grip a bit or tool 7.

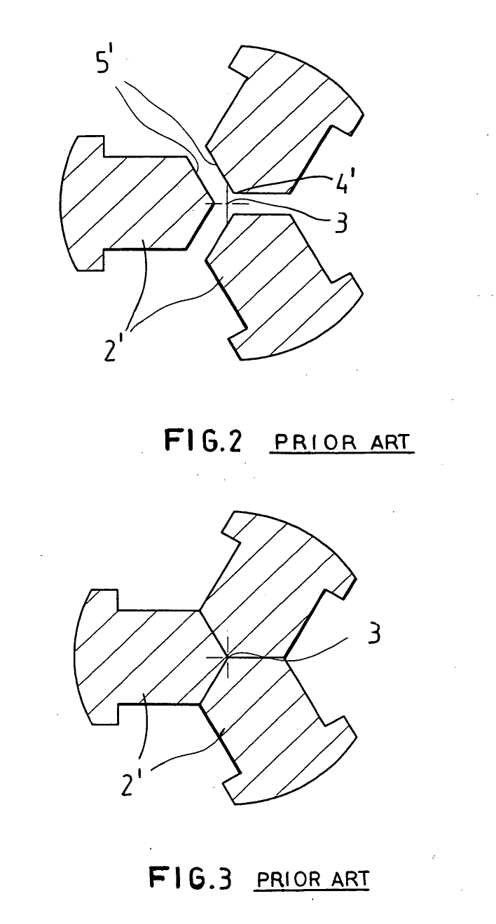

FIGS. 2-5 show prior-art jaws 2′ that each have a grip edge 4′ formed between a pair of planar flanks 5′. The edges 4′ and flanks 5′ are always parallel to the axis 3, in both the fully outer or open position of FIG. 2 or the fully closed position of FIG. 3. The two flanks 5′ of each jaw 2′, however, form an angle of 120° with each other so that in the closed position of FIG. 3 they bear flatly on each other. As a rule the angle formed by the jaw flanks in a standard prior-art chuck is exactly equal to 360° divided by the number of jaws.

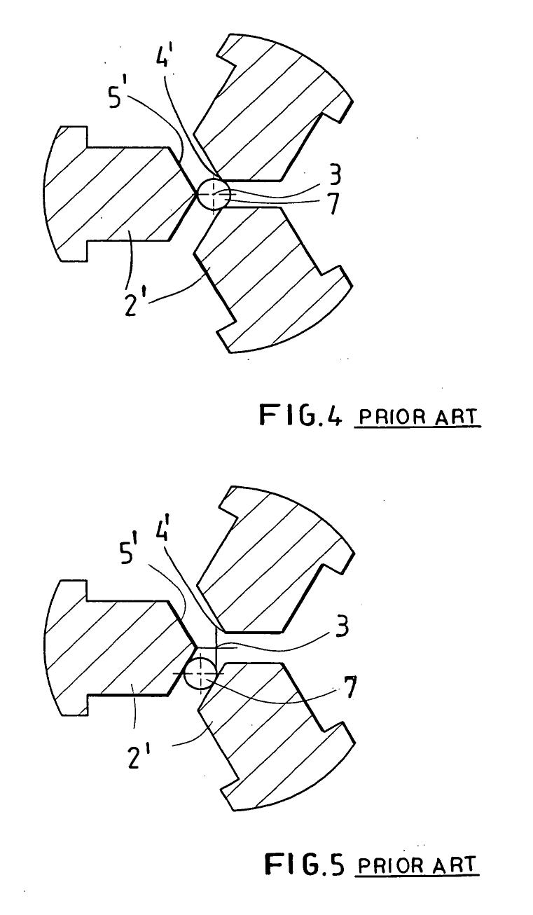

This construction works perfectly when the tool 7 is perfectly centered between the jaws 2′ so that it can be gripped in line contact by the three edges 4′ as shown in FIG. 4. When, however, the tool 7 slips in the open position between the flanks 5′ and the chuck is tightened, the tool 7 will be actually clamped between these flanks 5′. The user of the chuck will not necessarily notice this because the chuck will tighten normally, but when the drill is started the tool 7 will orbit about the axis 3 and probably come loose, as it is only held between two parallel surfaces, not between three edges.

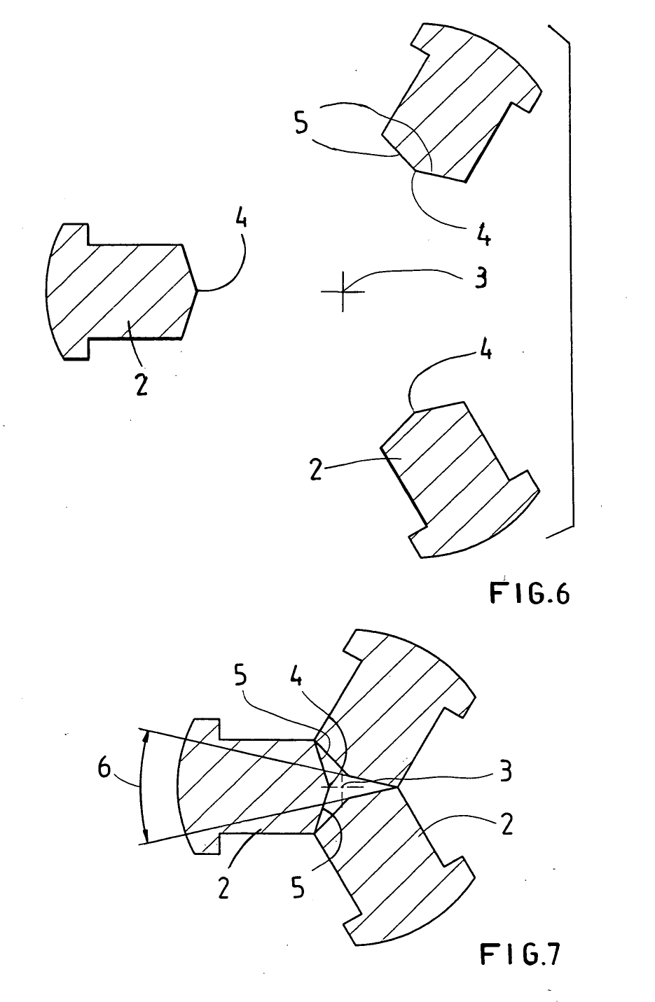

This problem is solved according to the invention by a system where as shown in FIGS. 6 and 7 the jaws 2 have grip edges 4 that are formed by flanks 5 that extend at more than 120° to each other. Thus each flank 5 forms with the adjacent flank 5 of the adjacent jaw 2 a radially inwardly open acute angle 6. Here the jaws 2 are symmetrical to planes 8 passing through the respective edges 4 and axis 3.

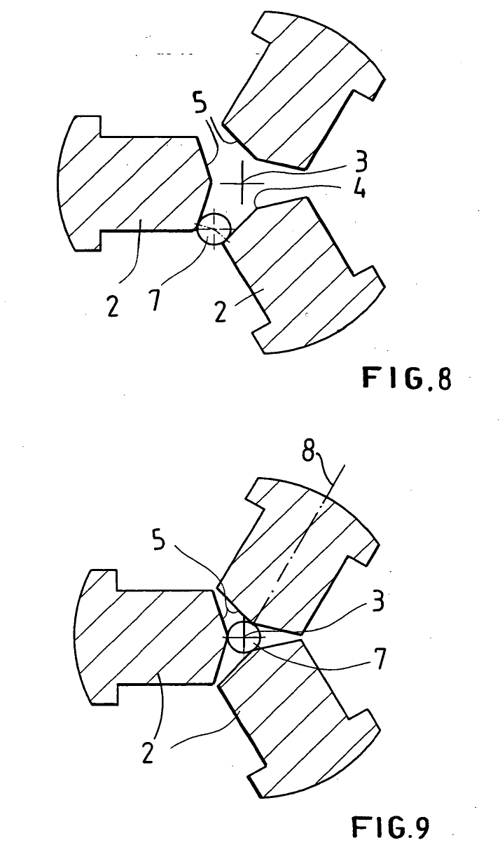

As a result as shown in FIGS. 8 and 9, when a tool 7 is fitted off-center in the chuck, closing the jaws 2 together will shift the tool 7 inward until it is centered on the axis 3. There will be no chance of mischucking the tool 7.

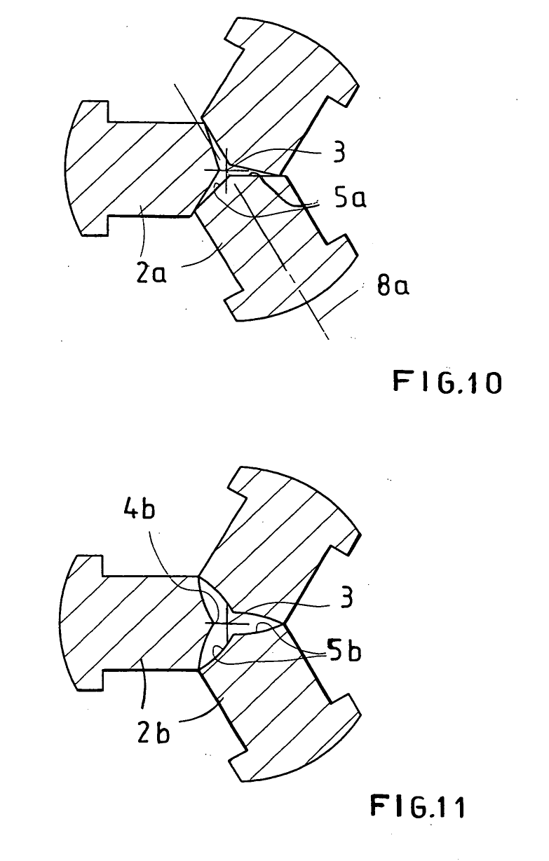

FIG. 10 shows a variation on this system where jaws 2a have flanks 5a that do not extend at the same angle to respective jaw planes 8a. Thus here in the closed position one outer edge of each jaw 2a engages a flank 5a of the adjacent jaw 2a, rather than the adjacent outer edge ss in FIG. 7.

In FIG. 11 the jaws 2b have inwardly concave flanks 5b that form edges 4b. In spite of the curvature of the part-cylindrical flanks 5b, each flank 5b diverges radially inwardly at all points from the adjacent flank 5b for the desired tool-centering action.

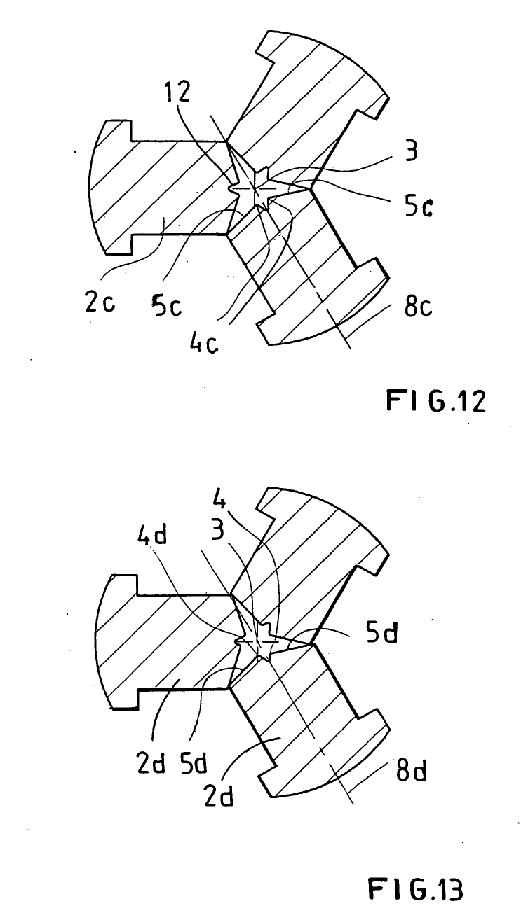

FIG. 12 shows a structure where jaws 2c have planar flanks 5c that flank a central groove 12 lying on the respective symmetry plane 8c and therefore defining a pair of grip edges 4c.

The system of FIG. 13 is similar to that of FIG. 12, except that the jaws 2d are not symmetrical, so that their flanks 5d are set at different angles like the flanks 5a of FIG. 10, which inherently sets the two edges 4d at different radial spacings from the axis 3. Here, as in FIG. 10, the plane 8d is not a center plane of the jaw 2d, although it does include the axis 3.

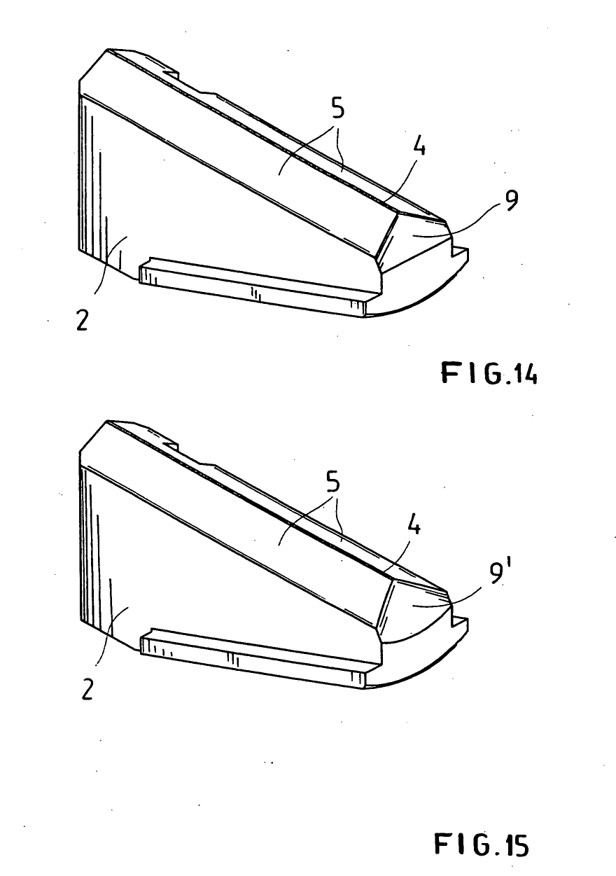

FIG. 14 shows that in the direction of introduction of the tool 7 or the workpiece 7 an end face of the jaw 2 has a plane 9 extending from the base of the jaws at an angle with respect to the chuck axis 3. This region may also be designed as a concave surface 9′ according to FIG. 15. It is obvious that all of the above refinements may also be provided for jaws 2 designed as round jaws, that is having part-cylindrical inner edges, so long as the curvature is such that adjacent side “flanks” diverge radially inward.

I claim:

1. A drill chuck comprising:
a chuck body centered on and rotatable about an axis; and
a plurality of jaws spaced angularly about the axis, radially shiftable on the body between inner and outer positions, and each having a grip edge extending along a line substantially parallel to the axis and a pair of flanks meeting at the grip edge and extending generally radially outward therefrom, the flanks of each jaw diverging radially inward from the flanks of adjacent jaws, whereby a tool shank engaged between the flanks of two adjacent jaws will be pushed radially toward the axis on movement of the jaws inward from the outer positions.

2. The drill chuck defined in claim 1 wherein the flanks of each jaw form with the flanks of adjacent jaws radially inwardly open acute angles.

3. The drill chuck defined in claim 2 wherein there are three jaws and the flanks of each jaw form an angle of more than 120°.

4. The drill chuck defined in claim 3 wherein there is a predetermined number n of jaws and the flanks of each jaw form an angle greater than 360°/n.

5. The drill chuck defined in claim 1 wherein the flanks of each jaw extend symmetrically from a plane bisecting the respective jaw and including the axis.

6. The drill chuck defined in claim 1 wherein the flanks of each jaw extend at different angles to a plane including the axis and passing radially through the respective jaw.

7. The drill chuck defined in claim 1 wherein each flank is inwardly concave.

8. The drill chuck defined in claim 7 wherein each flank is part-cylindrical.

9. The drill chuck defined in claim 1 wherein each jaw is formed between the respective flanks with a central groove extending parallel to the axis and defining with the respective flanks two such grip edges.

10. The drill chuck defined in claim 9 wherein the jaws are each symmetrical to a radial plane including the axis and bisecting the respective groove.

11. The drill chuck defined in claim 9 wherein the flanks of each jaw extend at different angles from a radial plane including the axis and bisecting the respective groove.

12. The drill chuck defined in claim 1 wherein each jaw has an axially directed end face extending at an acute angle to the axis.

13. The drill chuck defined in claim 12 wherein the end faces are planar.

14. The drill chuck defined in claim 12 wherein the end faces are arcuately concave.
